(19) United States
(12) Patent Application Publication
(10) Pub. No.: US 2002/0190856 A1
(43) Pub. Date: Dec. 19, 2002

(54) Wireless vehicle detection systems

(75) Inventor: Charles K. Howard, Detroit, MI (US)

Correspondence Address: ROPES & GRAY, ONE INTERNATIONAL PLACE, BOSTON, MA, 02110-2624, US

(73) Assignee: VehicleSense, Inc., Cambridge, MA

(21) Appl. No.: 10/064,037

(22) Filed: Jun. 4, 2002

Related U.S. Application Data
(60) Provisional application No. 60/295,602, filed on Jun. 4, 2001.

(51) Int. Cl. G08B 1/00

(52) U.S. Cl. 340/531; 340/552; 340/506

(57) ABSTRACT

The vehicle detection system described herein uses wireless magnetic sensors to measure changes in the earth's magnetic field to detect vehicles. The sensors may measure the presence and location of a vehicle, as well as the speed of passing vehicles. The sensor may also be capable of identifying and classifying vehicles. Each sensor and/or sensor system may be configured to consume so little power that it can operate from a battery for up to 10 years. While the preferred embodiment is wireless, the sensor and/or sensor systems may be configured to operate in a wired environment.

### CROSS REFERENCE TO RELATED APPLICATIONS

This application claims the benefit of U.S. Prov. App. No. 60/295602, filed Jun. 4, 2001.

### BACKGROUND OF THE INVENTION

Rules and regulations are commonplace for vehicular parking. Such rules may include absolute prohibitions, such as areas in which no parking is permitted, or the rules may include conditional prohibitions, such as permit-only parking. Metered parking is also typical on public roadways. In addition to various types of parking restrictions, the rules may be enforced by either private or public agencies.

Monitoring parking that is restricted in any of the above manners is costly and time consuming. Typically, a person must visually inspect all of the restricted spaces periodically, regardless of whether cars are actually there. This task becomes more difficult when the spaces are distributed over a large area, such as a city block or a large, multi-level parking garage. While parking monitoring systems have been described, they are typically limited to the detection of the presence or absence of a vehicle in a particular location. Such systems are employed, for example, in garages to provide occupancy statistics, and to direct vehicles to open spaces. As a significant disadvantage, these so-called “smart” parking systems of the prior art employ transducers hardwired into a parking detection network. These systems cannot be retrofitted to existing parking structures or infrastructures. As a further disadvantage, existing systems are typically limited to a single type or mode of detection, although various types of parking-related data may be obtained using signals from, for example, a magnetic transducer.

There remains a need for wireless vehicle detectors that can be deployed in parking applications and provide various types of vehicle detection.

### SUMMARY OF THE INVENTION

The vehicle detection system described herein uses wireless magnetic sensors to measure changes in the earth's magnetic field to detect vehicles. The sensors may measure the presence and location of a vehicle, as well as the speed of passing vehicles. The sensor may also be capable of identifying and classifying vehicles. Each sensor and/or sensor system may be configured to consume so little power that it can operate from a battery for up to 10 years. While the preferred embodiment is wireless, the sensor and/or sensor systems may be configured to operate in a wired environment.

### BRIEF DESCRIPTION OF DRAWINGS

The invention is pointed out with particularity in the appended claims. The advantages of the invention may be better understood by referring to the following description taken in conjunction with the accompanying drawing in which:

FIG. 1 is a block diagram of a wireless vehicle detector;

FIG. 2 is a block diagram of a wireless vehicle detector;

FIG. 3 is a flow chart depicting a method of operation of a wireless vehicle detector;

FIG. 4 is a state diagram depicting operation of a wireless vehicle detector;

FIGS. 5A and 5B depict an enclosure for a wireless vehicle detector; and

FIG. 6 is a block diagram of a control system for wireless vehicle detectors.

### DETAILED DESCRIPTION

To provide an overall understanding of the invention, certain illustrative embodiments will now be described, including vehicle detectors in a wireless parking system. However, it will be understood that the methods and systems described herein can be suitably adapted to other applications and environments where a number of physical spaces are managed for occupancy, such as dockage at a marina. All such variations are intended to fall within the scope of the invention described below.

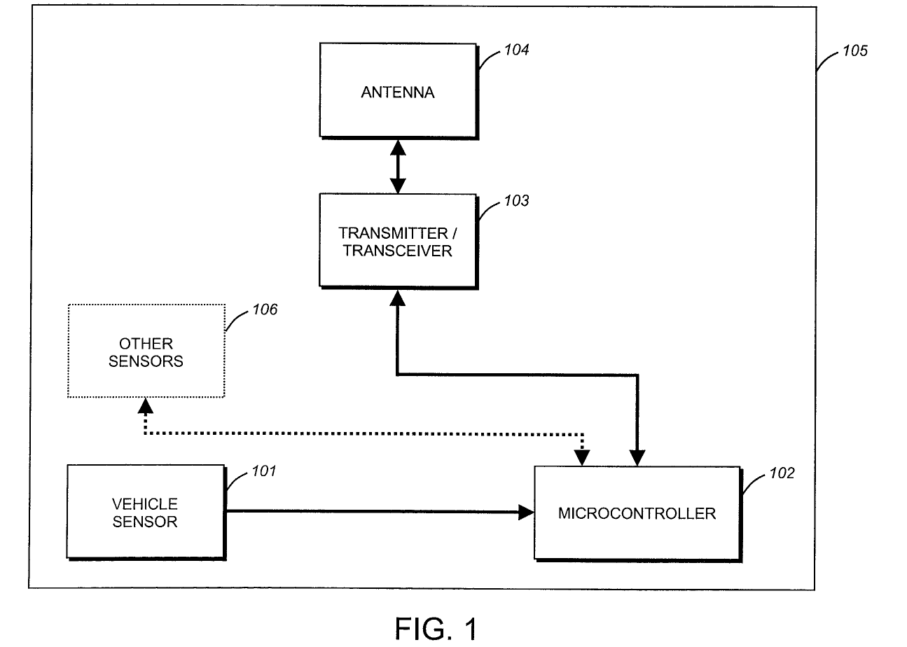

FIG. 1 is a block diagram of a wireless vehicle detector. The detector 105 may include a vehicle sensor 101, a microcontroller 102, a transmitter/transceiver 103 and an antenna 104. The vehicle sensor 101 is in electrical communication with the microcontroller 102 which is in turn in electrical communication with the transmitter 103, and each provides an output signal relating to the respective sensed information. Generally, the transmitter 103 transforms the information received from the sensors 101 into a form suitable for wireless communication via the antenna 104, and broadcasts the transformed information through wireless transmissions. The sensor information is typically available as baseband electrical signals, such as voltage or current levels, or sequences of binary digits, or bits, of information. The detector 105 may contain other vehicle sensors 101 to detect speed and provide greater signal resolution. The surface sensor may also contain other sensors 106 such as temperature sensors, precipitation sensors, and chemical analysis sensors.

In general, the antenna 104 may be any transducer capable of converting electrical into wireless broadcast signals. Examples of transducers include antennas, such as those typically used in wireless radio frequency (RF) communications; electrical-optical converters, such as light emitting diodes, lasers, photodiodes; and acoustic devices, such as piezoelectric transducers. In a preferred embodiment, the antenna 104 is an electrical antenna, designed for operation in the frequency range between 800 MHz and 2,500 MHz, generally known as the ultrahigh frequency (UHF) band. The UHF frequency band is particularly well suited to the detector 105 application because UHF circuits and components are relatively small in size and consume relatively low power.

In a particularly preferred embodiment, the antenna 104 is a microstrip patch antenna 104 operating within the frequency range of 902 mHz to 928 mHz. Microstrip patch antennas are relatively small compared with other resonant antennas, such as dipole antennas, operating over the same frequency range. Microstrip patch antennas are also rugged, easily designed and fabricated and relatively inexpensive. Although it may be desirable to operate at even higher frequencies, other considerations, such as government regulation, may stand in the way. For example, transmitting RF signals within certain frequency bands may be prohibited altogether, while use of other frequency bands may be restricted to special users, such as airlines or the military. Operation within the 902 mHz to 928 mHz frequency band is largely available for industrial, science and medical applications.

The detector 105 may be configured for installation beneath, beside or overhead the surface to be scanned. The sensor is particularly well suited to such an installation because of its compact size and its ability to operate without external interconnects, e.g., connections to the electrical power grid or to a receiver. Furthermore, the detector 105 may be configured in a single, self-contained and environmentally-sealed package. The detector 105 may be installed completely beneath a surface or partially beneath the surface, with some portion of the detector 105 exposed to the road surface. With currently available components, a detector 105 may be configured to have a volume of less than three cubic inches. Installation of such a detector 105 requires minimal disturbance to an existing infrastructure.

The vehicle sensor 101 may be a magnetic sensor, as described in more detail below. The other sensors 106 may include, for example, a vibrational sensor that employs a piezoelectric transducer pressure variations into electrical signals. The electrical signal may be amplified and conditioned to detect the presence of vehicular traffic. Different categories of vehicle typically impart different vibrations to the roadway surface depending on such factors as the weight of the vehicle, the type of motor and wheels, etc. The output signal of the vibrational sensor 106 may be correlated to categories of vehicle based on, for example, peak or average amplitude values, the amplitude profile, the duration, and spectral content. Ranges of these parameters associated with different types of vehicle may be stored within the detector 105 in the form of a database, which is addressed when signals are detected.

In some embodiments the vibrational sensor 106 may include an in-air or contact microphone, such as an electret microphone (e.g., the model EM9765-422 manufactured by Horn Industrial Co. Ltd., Shenzhen, Guangdong, China, or the model WM-54B, manufactured by Panasonic Industrial Company, Secaucus, N.J.). In other embodiments, accelerometers may be used to detect vibrations, such as the model ADXL202 dual-axis, low power, low voltage, digital output accelerometer, manufactured by Analog Devices. Other components and implementational details are described in Knaian, A Wireless Sensor Network for Smart Roadbeds and Intelligent Transportation Systems (graduate thesis on file at Massachusetts Institute of Technology), the entirety of which is hereby incorporated by reference.

In some embodiments, the vibrational sensor 106 may include a low power, or even passive (i.e., consuming virtually no power) acoustic or acceleration sensing element. The vibrational sensor 106 may be used to enhance the power conservation features of the detector 105. In such an application, the sensor detector 105 may operate in a default low-power operational mode, or inactive mode, where elements of the sensor, including the magnetic field sensing element, are normally inactive. When the vibrational sensor 106 senses through roadway vibrations that a vehicle may be approaching, the vibrational sensor 106 transmits a signal to other elements of the detector 105, e.g., to the microcontroller 102, to activate the other elements of the detector 105. In this way, vibrations resulting from an approaching vehicle cause a suitably configured sensor 101 to activate and operate as previously described (e.g., sensing the vehicle through perturbations to the ambient magnetic field). The vibrational sensor 106 may also be configured to transmit a signal to the microcontroller 105 after some predetermined period of inactivity to resume low-power operation (e.g., return to a “sleep mode”).

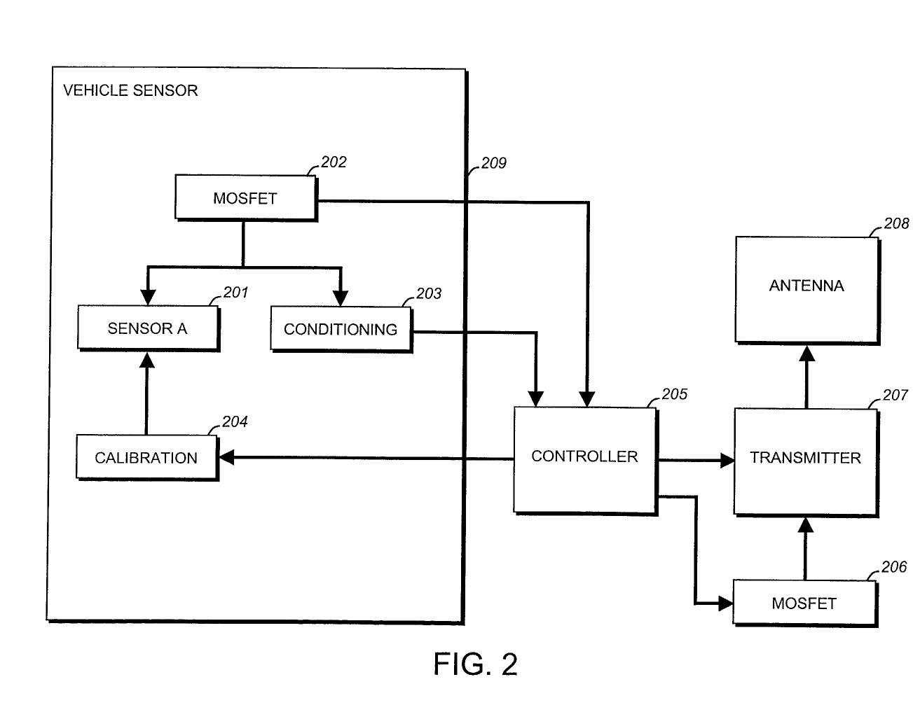

FIG. 2 is a block diagram of a wireless vehicle detector. The detector includes a controller 205 in communication with a sensor 209 and with a transmitter 207. The controller 205, the sensor 209 and the transmitter 207 are also connected to a power source (not shown) such as an internal or parasitic electrical power source. Interconnections to the power source may be established through one or more power control devices 206, or 202, offering the advantage of controlling and sharing power in an efficient manner. In one embodiment, the sensor 209 includes a sensor transducer (“sensor A”) 201, such as a magnetic sensing element, and a signal conditioning circuit 203 that receives signals from the sensor transducer 201. A calibration device 204 may provide a bias, or offset, or perform a calibration of the sensor transducer 201. The sensor 209 may also include multiple sensor trandsucers 201 in the same and/or different axes to improve reliability through redundancy, or to support additional sensing capabilities, such as sensing the direction and average speed of vehicles passing the sensor 209.

The controller 205 may perform control functions for the surface vehicle sensor. The controller 205 may also perform other overhead functions, such as input/output (I/O) and communications control, data formatting, power management, timing and synchronization.

The sensor 209 receives power from a local electrical power source through the power control device 202. One power control device 202 may provide power to both the sensor 209 and the control/transceiver circuits 205, 207, 208, or separate power control devices 202, 206 may be used. The sensor 209 receives electrical power and senses a surface condition that varies in relation to the presence of a vehicle, providing an electrical output signal relating to the sensed information. In some embodiments, the output signal from the sensor transducer 201 may require conditioning, such as amplification, filtration, or conversion, such as analog to digital (A/D) conversion. Where signal conditioning is required, the output signal from the sensor transducer 201 may be amplified by the conditioning circuit 203. The controller 205 receives the signal and may perform processing thereon.

In one embodiment, the sensor transducer 201 senses the presence of vehicles on the roadway by sensing perturbations to the ambient magnetic field. In a preferred embodiment, the sensor transducer 201 is an anisotropic magnetoresistive sensing element, such as device number HMC1021S, manufactured by Honeywell, Plymouth, Minn. Magnetoresistive sensing elements, when immersed in a magnetic field, convert the magnetic field into a voltage output, such as a differential output voltage. Typically, magnetoresistive sensing elements are relatively small (e.g., standard, 8-pin dual-inline package and smaller), low cost, highly reliable and capable of sensing low-level magnetic fields (e.g., 30 micro-gauss). Anisotropic magnetoresistive sensors are typically made from a thin film of nickel-iron (PERMALLOY) patterned onto a silicon wafer as a resistive strip. The HMC1021S device includes a Wheatstone bridge with one leg of the bridge having such a strip. When a potential of 3.0 volts is applied to the bridge, and the on-axis magnetic field strength can be read across the bridge as a voltage of 3.0 millivolts/gauss. Other suitable vehicle sensors include inductive sensors, pressure sensors, vibration sensors, optical sensors, and other active sensors communicating with the passing vehicles.

Signal processing may include, for example, determining the presence of a vehicle, counting the numbers of sensed vehicles, determining the speed of sensed vehicles, determining the magnetic signature of the vehicle, determining the class of the sensed vehicles, determining the identity of sensed vehicles, and other characteristics that may be sensed with the sensor 209 and buffering any information to be broadcast. In one embodiment, the controller 205 provides an output signal corresponding to the vehicle sensor output signal to the transmitter 207. The controller 205 may also provide timing, monitoring, and control information to the transmitter 207 to frequency tune the transmitter, to control the periods of broadcast, and the like. The transmitter 207 broadcasts the information provided by the controller 205, under the control of the controller 205, to a remote destination. The transmitter 207 may also receive electrical power through a controllable power device. The transmitter 207 may be configured to transmit information periodically, such as when an event is sensed, e.g., a vehicle passing the sensor, or periodically after some time delay where sensed information is buffered within the sensor.

The signal conditioning circuit 203 may include an instrumentation amplifier having a low-voltage supply requirement and having a fast settling time; a suitable device is the INA155 component (Burr-Brown device number) manufactured by Texas Instruments Inc., Dallas, Tex. For embodiments where the sensor transducer 201 generates a differential signal, the instrumentation amplifier also converts it to a single-ended signal. In some embodiments, the output from the instrumentation amplifier is amplified further by an operational amplifier, such as device number OP162, manufactured by Analog Devices, Norwood, Massachusetts.

The sensor transducer 201 may require the application of an external signal for calibration or to establish an offset bias. These functions are provided by the calibration device 204, which is in communication with the sensor transducer 201 and the controller 205. The calibration device 204 receives an input signal from the controller 205 and in response applies an output signal to the sensor transducer 201 in accordance with the needed calibration or offset function.

In one embodiment, the electrical power source for the sensor is a battery (not shown) capable of powering the detector of FIG. 2. In one embodiment, the electrical power is applied to the sensor 209 and to the transmitter 207 through the power control devices 202, 206. In a preferred embodiment, the battery is compact and capable of storing a substantial charge for a relatively long time, e.g., several years. In a preferred embodiment, the battery is a lithium battery such as a lithium thionylchloride battery.

The power control devices 202, 206 receive input power from the power source, provide power to a load through an output, and are capable of being operated to control the amount of power delivered to the load. In some embodiments, the power control devices are transistors, and may be, for example, P-channel enhancement mode, metal-oxide semiconductor field effect transistors (MOSFETs), such as device number Si2301 manufactured by Siliconix Inc., Santa Clara, Calif. The power control device 202 or 206 may be controlled by the controller 205 through a control port. It may be advantageous to control the power to the different elements of the sensor in order to limit the overall power consumption. In particular, dynamically redistributing power to the different elements of the sensor preserves the limited available power from the power source. Indeed, an surface vehicle sensor of the kind described herein might be capable of operating for up to ten years with a single, compact battery source. For example, where the transmitter 207 transmits periodically, power is required during periods of transmission and not during idle periods.

The transmitter 207 may include a buffer for receiving and storing information from the sensor 209. Alternatively, a buffer may be included within the controller 205. The transmitter 207 may also include, for example, a modulator for modulating a carrier signal with information derived from the sensors. The transmitter 207 may also include a mixer for translating the modulated signal to a desired RF frequency of operation, an amplifier amplifying the transmitted signal to a sufficient signal strength to support wireless communications with the remote destination, a local oscillator for supplying a reference signal, and a transmission controller for controlling the overall operation of the transmitter 207. The buffer receives sensed information from the controller 205, and provides the sensed information as an output signal to the modulator. The modulator, in turn, is in communication with the RF amplifier through the mixer, and may be in electrical communication with the modulator and the local oscillator.

The information received by the buffer originates with the sensor 209. The buffer temporarily stores the received sensor information until the transmitter 207 broadcasts the information. The modulator receives a first signal containing baseband data received from the buffer. The modulator impresses the received baseband data of the first signal onto a second signal, which may be an intermediate signal having a dominant frequency component other than the baseband signal or the RF signal; the intermediate signal is transformed to an RF broadcast signal before exiting the transmitter 207. Alternatively, the second signal may be the broadcast signal itself. For example, in an RF transmitter, the baseband signal may be a relatively low-frequency signal, e.g., 2400 bits per second (bps). This signal is provided to the modulator and the modulator, in turn, changes some aspect of an intermediate signal, such as an audio-frequency (10,000 Hz) tone, or the broadcast signal, such as a 928 MHz RF signal. The modulator may change the amplitude, the frequency, or the phase of the intermediate signal according to the baseband data.

In one embodiment, the transmitter 207 is a frequency shift keying (FSK) transmitter. The FSK transmitter modulates a tone between two or more frequencies according to the value of the baseband data. For example, a baseband input of a binary “0” into the modulator may result in an intermediate 10,000 Hz signal output. Likewise, a baseband input of a binary “1” into the modulator may result in an intermediate 20,000 Hz signal. The modulator output is a signal having an instantaneous frequency of either 10,000 Hz or 20,000 Hz, depending on whether the output corresponds to a binary “0” or a binary “1”, respectively. Preferably the amplitude of the envelope of the modulator output signal is also substantially constant. The modulated intermediate signal at the output of the modulator is translated to an RF broadcast signal suitable for broadcast through the antenna 208. In some embodiments, the transmitter 207 may be frequency agile, while in other embodiments, the transmitter 207 may be a spread-spectrum transmitter, using such techniques as frequency hopping or code division multiple access (CDMA).

The mixer has three ports: an intermediate frequency (IF) input port, a local oscillator (LO) input port, and an RF output port. The IF port of the mixer receives the modulated intermediate signal from the modulator. The LO port of the mixer receives an RF reference signal from the local oscillator. The mixer produces an output substantially corresponding to the sum and difference of the signals at the IF port and the LO port (i.e., the local output signal frequency of the oscillator and the intermediate signal frequency).

The amplifier amplifies the RF broadcast signal to an amplitude suitable for wireless transmission to an intended external destination through the antenna 208. The amplifier may be a standard RF amplifier and may include a filtration stage to filter any unwanted output products of the mixer. For example, where the intermediate frequency is 10,000 Hz and the local oscillator frequency is 928 mHz, the output of the mixer would be 928.010 MHz and 927.990 MHz. The amplifier filtration stage may attenuate the unwanted of the two mixer output signals (e.g., 927.990 MHz) while amplifying the other (e.g., 928.010 Generally, operating multiple sensors within the same general proximity may result in unwanted interference. For example, if two sensors communicating with the same remote destination broadcast information at the same time and on the same frequency, neither signal may be discernable and the transmissions will be lost. Interference may be avoided by using multiplexing techniques, such as assigned frequencies or assigned broadcast intervals for individual sensors. In one embodiment, the transmitter 207 is configured to operate according to a sparse-TDMA transmission protocol. The sparse-TDMA protocol includes a master time interval (e.g., 60 seconds) that is arbitrarily divided up into a number of time slots (e.g., 7693 time slots, each of 7.8 milliseconds duration). In one embodiment, each detector 209 may randomly select a time slot and broadcast its information in that slot. With each transmitter 207 operating according to such a protocol, the probability of interference can be reduced.

The transmitter 207 may be a bi-directional transceiver configured to receive data as well as transmitting data. A suitably configured receiver receives wireless signals through the antenna 208 and converts the wireless signals into electrical signals. Such a receive capability is particularly useful for performing remote diagnostics or remote repair (e.g., receiving updated system firmware). Since the receive capability represents another power dissipation source, the receive capability may be configured to operate periodically. For example, the receiver may routinely operate only during a predetermined duration of time and according to a predetermined period (e.g., the receiver operates for five minutes each day at 12 o'clock). Occasionally, any extended periods of operation that may be required, such as during a firmware upgrade, could be negotiated during the routinely occurring operational periods.

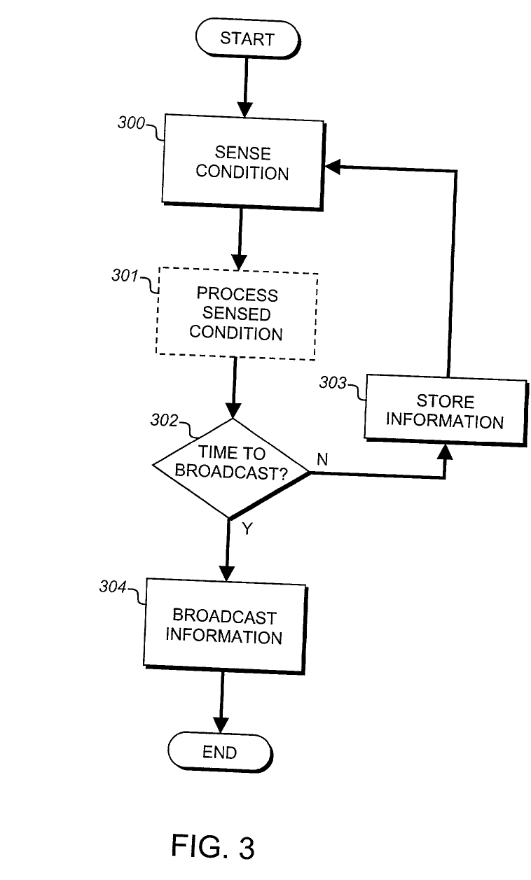

FIG. 3 is a flow chart depicting a method of operation of a wireless vehicle detector. The process begins when one or more sensors sense a condition 300, such as the presence of a vehicle. Optionally, the sensors may process the sensed information 301, or provide the sensed information directly to the controller for processing, or processing may occur at both the sensors and at the controller. Processing may include signal conditioning, such as amplification, attenuation, or filtering; or signal conversion, such as A/D conversion. Processing may also include manipulation of the sensed information to determine other roadway conditions. For example, where the sensor is equipped with two vehicle sensing elements, processing may be used to determine the direction of traffic depending on which sensing element, first reports the presence of the vehicle. Processing may also be used to determine the average speed of a passing vehicle by dividing the baseline separation of the two sensors, by the time difference that the vehicle is sensed by each sensor. In one embodiment, the vehicle sensing element senses the presence of vehicles on a surface by sensing perturbations to the ambient magnetic field. In a preferred embodiment, the vehicle sensing element is an anisotropic magnetoresistive sensing element. Other suitable vehicle sensors include inductive sensors, pressure sensors, vibration sensors, optical sensors, and other active sensors detecting the presence of vehicles.

As shown in step 302, it may then be determined whether it is time to broadcast sensor data. Broadcast intervals may be variable or fixed. For example, the time to broadcast may occur at specific time intervals, e.g., once every thirty seconds, once every minute, or once every five minutes. The interval may be significantly less than thirty seconds or significantly more than five minutes, depending on a particular application for which the wireless vehicle detector is used. Optionally, the time to broadcast may be initiated by a signal received through the detector“s transceiver from a base station. This signal may be transmitted to the detector at any desired regular or irregular interval. In another embodiment, the time to broadcast may be dynamically determined, such as by the amount of data stored in a buffer for broadcast. Some combination of these techniques may also be used, such as a determining the time to broadcast at the detector by analyzing an amount of data in the buffer, and simultaneously permitting the base station to override the detector's internal monitor and request transmission.

If it is not time to broadcast, then the process continues to step 303 where the information is stored, or buffered. The process then returns to step 300 where a subsequent condition is sensed. In an application where the sensor periodically transmits information to a remote destination, the sensed and processed information may be temporarily buffered. At any instant of time, the transmitter may be either actively transmitting or not transmitting, or silent. During periods of transmission, the transmitter transmits some or all of the information from the buffer. Periodic transmissions are well adapted to applications where relatively small amounts of data are transferred and offer the advantages of both power conservation and efficient utilization of limited frequency bandwidth.

When it is determined in step 302 that it is time to broadcast, the system proceeds to step 304 where the information is broadcast. In one embodiment, the transmitter uses a sparse time division multiple access (TDMA) multiplexing protocol to support multiple sensors each sensor transmitting sensed information to a remote destination on the same frequency. Any of the other transmission techniques described above may also be used.

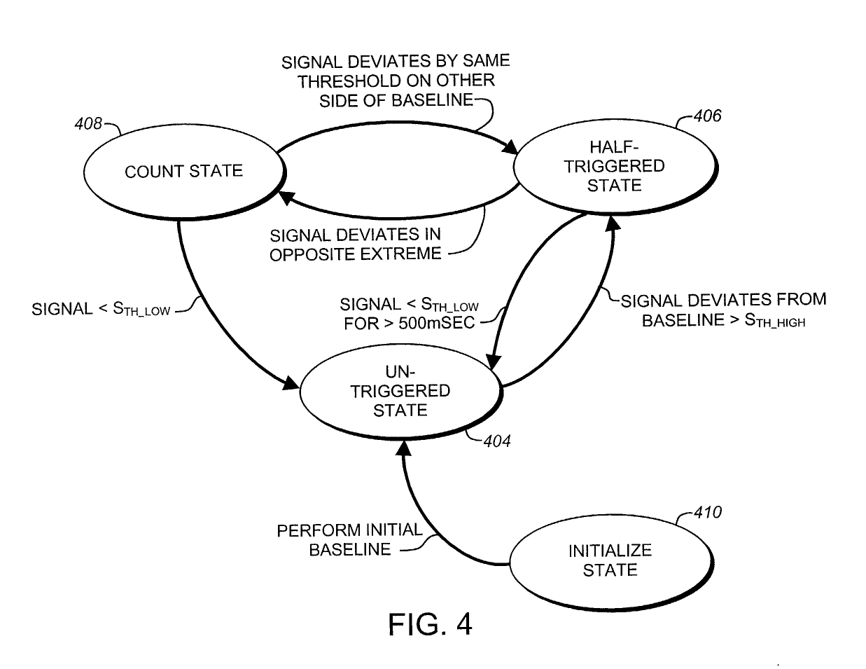

FIG. 4 is a state diagram depicting operation of a wireless vehicle detector. The state diagram may be realized as a state machine in code executed by the controller of the detector. The state machine depicted in FIG. 4 generally operates to count passing vehicles.

The state machine may be driven by the variation in the vehicle sensor output signal with respect to a baseline value. Generally, the magnetic field will vary in a similar fashion for a vehicle passing over the sensor, increasing from a baseline value to a maximum excursion in one direction (e.g., positive), followed by an excursion to a similar maximum value, but to the opposite side of the baseline (e.g., negative). In one embodiment, the state machine begins in an untriggered state 404. When the signal deviates by more than a first threshold (“S_{TH}_{_{—}}_{HIGH}”) from the baseline, the state machine progresses to a half-triggered state 406. If the signal deviates by more than the same threshold, but on the opposite side of the baseline, the state machine progresses to the count state 408, and a counter may be advanced indicating that a vehicle has passed the sensor. Before the state machine can count another vehicle, it must be first returned to either the untriggered state 404 or again to the half-triggered state 406. When the signal comes within a second threshold (“S_{TH}_{_{—}}_{LOW}”), smaller than the first threshold, the state machine transitions to the untriggered state 404 and is available to repeat the process when the next vehicle passes. If the state machine is in the half-triggered state 406 and the signal reduces below the second threshold for a period of time greater than a predetermined minimum, e.g., 500 milliseconds, without reaching the first threshold in the opposite side of the baseline, the state machine is returned to the untriggered state 404. The state machine may also return to the half-triggered state 406 directly from the count state 408, if the signal deviates again to the opposite extreme.

In one embodiment, the baseline value is established during an initialize state 410 that occurs over a period of time, e.g., 10 seconds, after initial power on. When the state machine is untriggered, the measurement baseline is continuously adjusted to compensate for changes in the ambient magnetic field and to maintain measurement fidelity. For example, the measurement baseline may be adjusted upward by some amount, e.g., 1/10 of a count per sample, if the signal is above the baseline and downward by some amount, e.g., 1/10 of a count per sample, if the signal is below the baseline. When the state machine is in any state other than the untriggered state, the baseline may be adjusted in a similar manner, but using a smaller increment, e.g., 1/100 of a count per sample.

The output of the sensor may also be digitized and analyzed to detect other events. For example, where a signal output by the sensor rises quickly to a maximum and then decays relatively slowly back to the baseline, it can be inferred that a vehicle has stopped above the sensor and is present at that location. By contrast, where a sharp negative response is followed by a decay back to the baseline, it can be inferred that a vehicle has left the spot. It should be noted that the polarity is relative in these measurements, and either one may be negative or positive. However, the polarity of a signal from a vehicle stopping above the sensor will be the opposite of the polarity of a signal from a vehicle leaving the area above the sensor.

Similarly a sensor or combination of sensors may be provided to detect a direction of a passing vehicle. For example two consecutive, similar sensors may be arranged along a roadway. Each may have a similar response to a passing vehicle, with the rate of travel of the vehicle discernible from a phase difference or delay between the response of the two sensors. In this manner, a number of sensors may be arranged in zones to track traffic movement. For example, two sensors at an entrance to a garage and two sensors at an exit to the garage may be used to detect vehicular travel and rates into and out of the garage. Similarly, where a single road is shared by incoming and outgoing traffic, traffic direction may be used to indirectly track a number of vehicles presently in the garage. Similar zones may be used to track vehicular traffic on roads, at intersections, highway onramps and off ramps, and so forth. With properly arrayed zones and sufficient sensitivity of sensors, traffic speed and congestion may be measured.

In another application, the magnitude of a signal response may be used to estimate the size of a vehicle. A size measurement may also be estimated using, for example a combination of speed and time of passage of two consecutively arranged sensors on a roadway, or any of these techniques in combination with other sensor inputs, such as vibrational energy. More generally, the signal from a sensor may be used to distinguish among vehicle types. Each type of vehicle will have a unique magnetic signature, as measured when the vehicle passes over the magnetic sensor. This signal may be digitized, and compared to a database of vehicle signatures stored in a database, with vehicle type determination made by comparison, through any suitable computational technique (e.g., correlation), of a captured signal to database signatures. As a further enhancement, vehicles may be tagged to give them identifying magnetic signatures, which may be used to identify vehicle types of individual vehicles in, for example, a parking environment.

In certain embodiments, the sensor may be capable of measuring a direction of travel for a vehicle (e.g. whether the vehicle passed the sensor or stopped over it and backed up). In this embodiment, the state machine begins in an untriggered state. When the signal deviates by more than a first threshold (“S_{TH}_{_{—}}_{HIGH}”) from the baseline, the state machine progresses to a half-trigger state. If the signal deviates in a mirror image, then the state machine progresses to the reverse state. However if the signal continues to deviate from baseline the state machine progresses to the forward state. Before the state machine can determine the direction of another vehicle , it must first return to either the untriggered state, the initial baseline.

Where the sensor is a multi-axis magnetic sensing element, a single sensor may be capable of detecting direction of movement, as well as lack of movement, by a vehicle near the sensor. In this case the sensor signal may be processed, such as through the use of a state machine as described above, to obtain detailed information concerning vehicle movement around the sensor.

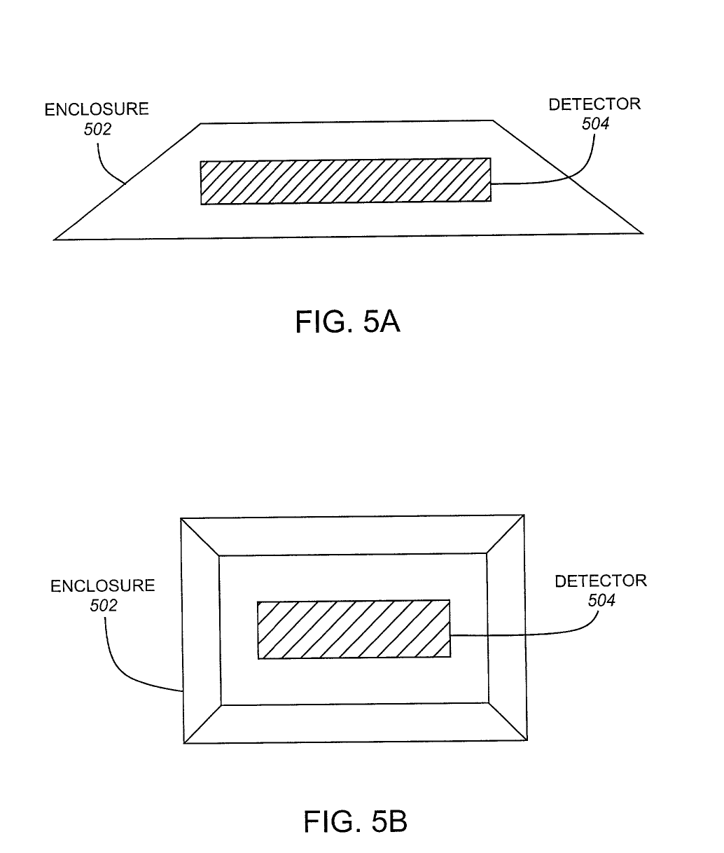

FIGS. 5A and 5B depict an enclosure for a wireless vehicle detector. FIG. 5A shows a profile of an enclosure 502 that surrounds and encases a detector 504, which may be, for example, any of the wireless vehicle detectors described above. The enclosure 502 may be a pavement reflector having a generally trapezoidal profile, such the type used to enhance roadway markings at night. The enclosure 502 may include a reflective surface such as plastic reflective material or reflective paint, in order to increase visibility during nighttime driving. The enclosure 502 may be molded of methyl methacrylate conforming to American Society for Testing and Materials (“ASTM”) D788 Grade 8, or material of similar properties. Filler may be potting compound selected for strength, resilience, and adhesion adequate to pass physical requirement for roadway use. Markers with length and width both equal to or greater than 4 inch may be fashioned of material, for example, to withstand load of at least 2000 lbs (909 kg) without breakage or significant deformation, consistent with load capability of commonly used roadway reflectors, as well as with protection of the enclosed detector 504. FIG. 5B shows the enclosure 502 and the reflector 504 from a top view. Other shapes and strengths of enclosures may be used according to an expected placement of the enclosure 502 and detector 504.

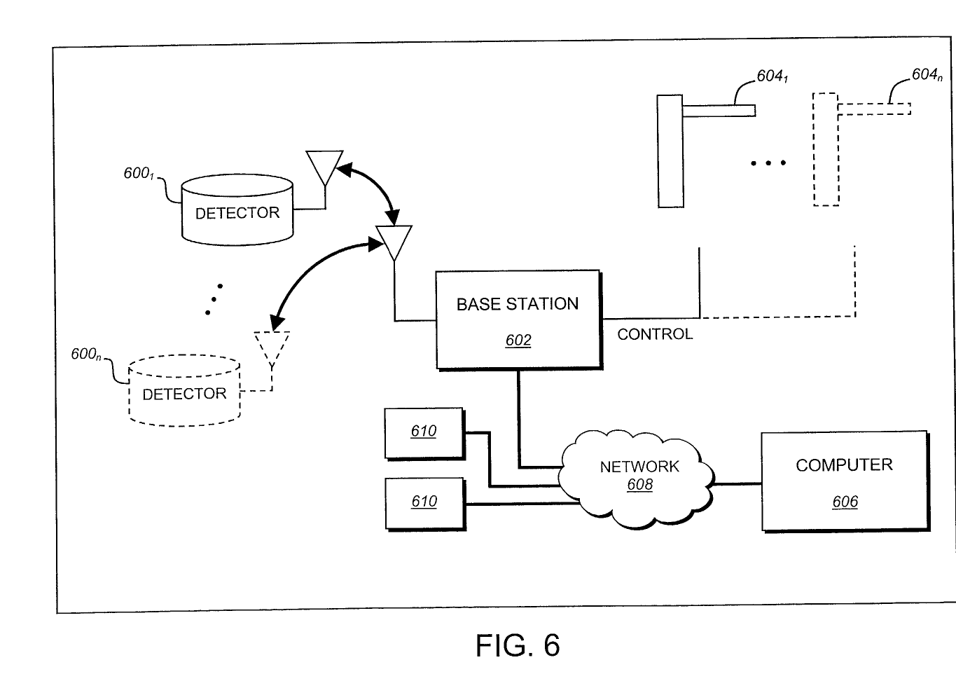

FIG. 6 is a block diagram of a control system for wireless vehicle detectors. The detectors 600 may be configured to monitor and/or control traffic, either on public roadways or within private roads, garages, or other complexes. A set of detectors, 600₁, . . . 600ₙ (generally 6000) are placed at strategic locations around a segment of roadway. The detectors 600, which may be, for example, any of the wireless vehicle detectors described above, may sense passing vehicles as previously described. The detectors 600 then broadcast information to a base station 602 associated with the respective set of detectors 600.

The base station 602 may include a processor that processes information from the detectors 600. The base station 602, in response to the received vehicle information from the detectors 600, may control one or more traffic control mechanisms 604₁, . . . 604ₙ (generally 604), or may log received data for subsequent review and analysis. The traffic control mechanisms 604 may include, for example, traffic lights, gates, arrows, and so forth. For example, at a roadway intersection, one or more detectors 600 may be placed in each lane approaching the intersection. As vehicles approach the intersection, the detectors 600 sense the passing vehicles and broadcast related information to the base station 602. The base station 602 may be located on a light pole or telephone pole, or some other convenient location, typically in the general vicinity of the intersection. Alternatively, the base station 602 may be located at a more remote distance from the detectors 600, limited only by the restrictions of the wireless communications link from the sensors 600 to the base station 602.

In this application, it may be advantageous for each of the detectors 600 to provide some form of identification allowing the base station 602 to distinguish which detector 600 is reporting a passing vehicle. Identification may be signaled by broadcasting a unique address tone, or bit sequence, broadcasting in a pre-assigned time slot, or broadcasting on an allocated frequency. The base station 602, being able to identify the reporting detector 600, is thereby apprised of which portion of the roadway segment (e.g., which lane) contains the approaching vehicle and can, for example, control the traffic control mechanisms 604 accordingly. Because the wireless communications link distances may be greater than one kilometer, it is possible to have a single base station controlling traffic flow at a number of different roadway segments. Integrating information from contiguous chains of segments can facilitate the control of overall traffic flow over relatively large metropolitan areas to avoid gridlock.

More generally, the detectors 600 may be arranged over zones of interest where there is vehicular traffic, and the locations of the detectors 600 recorded at the base station 602. Using the data received from the detectors 600, the base station 602 may characterize traffic flow throughout a zone or zones monitored by the detectors 600. Further processing may also be performed remotely by coupling the base station 602 to a remote computer 606, which includes a processor and other components of a conventional computer, over a network 608 such as the Internet. The remote computer 606 may be a web server.

Data from the detectors 600, as captured by the base station 602 and communicated to the computer 606, may be stored by the computer 606 made available on the Web, such as through a Web server application executing on the computer 606. In one embodiment, a Web application may be provided offering access to roadway sensed information as processed by the computer 606. Alternatively, a number of base stations 602 may be interconnected directly to the Internet 64, facilitating Web-based access thereto. This may serve as the basis upon which the computer 606 communicates with the base station 602, or may allow Web clients 610 to obtain information directly from the base station 602.

The computer 606 may respond to Web client 610 requests for traffic service in the form of a traffic report, travel route time estimate, or travel route planning to avoid traffic congestion, preparing the requested product and serving it to the requesting Web client 610. The control center 606 may make use of information routinely collected from the detectors 600, serving a Web client request with the latest available information. Alternatively, the computer 606 may request updates from the base stations 602 relevant to a Web client 610 request.

Having shown the preferred embodiments, one skilled in the art will realize that many variations are possible within the scope and spirit of the claimed invention. It is therefor the intention to limit the invention only by the scope of the following claims.

1] A wireless detector comprising:
a sensor that detects the presence of a vehicle;
a transmitter that wirelessly transmits data;
a controller that controls operation of the sensor, and that buffers sensor data and controls operation of the transmitter to transmit the sensor data at predetermined times; and
power control circuitry for intermittently powering the sensor.

2] The wireless detector of claim 1 further comprising a transceiver including the transmitter and a receiver that wirelessly receives data;

3] The wireless detector of claim 2 wherein the receiver is only active during limited time intervals.

4] The wireless detector of claim 1 wherein the transmitter transmits data using a sparse time-division multiplexed protocol.

5] The wireless detector of claim 1 wherein the power control circuitry intermittently powers the transmitter.

6] The wireless detector of claim 1 wherein the sensor includes one or more magnetic field sensors.

7] A system comprising a plurality of the wireless detectors of claim 1, the system further comprising a base station communicating with each of the plurality of wireless detectors, each one of the wireless detectors monitoring a parking space for a vehicle.

8] The wireless detector of claim 1 further comprising a vibrational sensor, the detector being activated in response to a vibration detected by the vibrational sensor, and the detector being deactivated in response to a period of time without a detected vibration.

9] The wireless detector of claim 1 further comprising a buffer that stores sensor data, the transmitter being activated when an amount of sensor data stored in the buffer reaches a predetermined threshold.

10] The wireless detector of claim 1 wherein a signal from the sensor is analyzed to determine a vehicle type.

11] An apparatus comprising:
a sensor that detects the presence of a vehicle;
a transmitter that wirelessly transmits data;
a controller that controls operation of the sensor, and that buffers sensor data and controls operation of the transmitter to transmit the sensor data at predetermined times;
power control circuitry that intermittently powers the sensor; and
a pavement reflector enclosing the sensor, the controller, and the transmitter, the pavement reflector suitable for withstanding vehicular traffic.

12] The apparatus of claim 11 wherein the pavement reflector is formed from methyl methacrylate.

13] An apparatus comprising:
a plurality of wireless vehicle detectors, each detecting the direction of vehicles, the wireless vehicle detectors arranged into zones;
a base station coupled in a communicating relationship with the plurality of wireless vehicle detectors, the base station receiving vehicle detection signals from each of the plurality of wireless vehicle detectors, and
a processor coupled in a communicating relationship with the base station, the processor receiving the vehicle detection signals from the base station and processing the vehicle detection signals to determine a movement of vehicles among the zones.

14] The apparatus of claim 13 wherein the processor is a component of the base station.

15] The apparatus of claim 13 wherein the processor resides on a computer accessible to the base station through a network.

16] The apparatus of claim 13, wherein the zones comprise zones arranged about an entrance and exit to a location, the base station processing the vehicle detection signals to track vehicles entering and exiting the location.

17] The apparatus of claim 13 wherein each one of the plurality of wireless vehicle detectors detects the presence of a vehicle in a parking space.

18] A wireless detector comprising:
a sensor means for detecting the presence of a vehicle;
a transmitter means for wirelessly transmitting data;
a control means for controlling operation of the sensor and buffering sensor data, and for controlling transmission of the sensor data at predetermined times; and
power control means for intermittently providing power to the sensor.

19] A method for conserving energy in a wireless vehicle detector comprising:
intermittently powering a sensor to gather data;
detecting the presence of a vehicle as sensor data;
buffering the sensor data; and
wirelessly transmitting the sensor data at predetermined times.

20] The method of claim 19 further comprising:
sensing vibrations of an approaching vehicle; and
in response to the sensed vibrations, powering the sensor to gather data.
